(19) United States
(12) Patent Application Publication
(10) Pub. No.: US 2007/0238361 A1
(43) Pub. Date: Oct. 11, 2007

(54) PRINTED CIRCUIT BOARD

(75) Inventor: Heishiro Fudo, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/697,187

(22) Filed: Apr. 5, 2007

(30) Foreign Application Priority Data
Apr. 6, 2006 (JP) 2006-105261

(51) Int. Cl. H01R 13/66

(52) U.S. Cl. 439/620.09

(57) ABSTRACT

A printed circuit board comprises an insulating substrate, a plurality of wiring members disposed on the insulating substrate, and a coating member that covers the wiring members and the insulating substrate between the wiring members. The wiring members include Ag, and the coating member is formed of an acrylic glass and a curing agent comprising hexamethylene diisocyanate.

### CLAIM FOR PRIORITY

This patent document claims the benefit of Japanese Patent Application No. 2006-105261, filed on Apr. 6, 2006, which is hereby incorporated by reference.

### BACKGROUND OF THE INVENTION

1. Field of the Invention

The present invention relates to a printed circuit board having excellent close adhesion and bendability as well as improved migration resistance.

2. Description of the Related Art

An Ag coated film is preferably used for wiring members of a printed circuit board in view of price, electric conductivity, bendability, and the like. The wiring members formed of the Ag coated film is disclosed in JP-A-1-151291.

The wiring members and an insulating substrate between the wiring members are covered by an insulating coating member. Conventionally, for example, a polyester resin has been used as the coating member.

When the Ag coated film is used for the wiring members, there is a problem in that a short or a disconnection is caused between the wiring members due to ion migration.

For example, where a flexible printed circuit board is used for a mobile phone, it is necessary to suitably suppress the ion migration that may be caused by further narrowing of pitch patterns between the wiring members or a poor environment in which the flexible printed circuit board is used.

In addition to the migration resistance, it is necessary to improve various features such as the bendability of the flexible printed circuit board or the close adhesion between the elements constituting the flexible printed circuit board, and more specifically, between the insulating substrate and the coating member and between the coating member and the wiring members.

For example, the ion migration may be prevented by changing a material for the conductive film material used in the wiring members. However, as described above, since the Ag coated film has excellent features, such as in price, electric conductivity, bendability, and workability, the invention is to solve the problems while using the Ag coated film as it is.

### SUMMARY OF THE INVENTION

Therefore, the present invention is contrived to solve the above-described problems, and its object is to provide a printed circuit board that has excellent close adhesion or bendability as well as improved migration resistance by suitably selecting a material for a coating member.

According to an aspect of the present invention, there is provided a printed circuit board that includes an insulating substrate, a plurality of wiring members formed on the insulating substrate, and a coating member that covers the wiring members and the insulating substrate between the wiring members, wherein the wiring members include at least Ag, and the coating member is formed of an acrylic glass and a curing agent comprising hexamethylene diisocyanate.

In the present invention, the acrylic glass and hexamethylene diisocyanate (HDI) as the curing agent are included in the coating member, as described above. Since the acrylic glass has strong water resistance, it is possible to improve the migration resistance by using the acrylic glass even when the wiring member including the Ag coated film is used. Moreover, sine at least HDI is included in the curing agent, it is possible to improve the bendability of the flexible printed circuit board and the close adhesion between the insulating substrate and the coating member and between the coating member and the wiring members.

In the present invention, it is preferable that the curing agent further comprises diphenylmethane diisocyanate (MDI). When the curing agent contains HDI only, it can be seen from experiments to be described later that noncohesiveness (non-tack property) on a surface of the coating member is lowered (that is, stickiness is increased). The noncohesiveness (non-tack property) can be properly improved by using a mixture of HDI and MDI.

In the present invention, it is preferable that the content of hexamethylene diisocyanate is in the range of about 33% to about 90% by mass when the total content of hexamethylene diisocyanate and diphenylmethane diisocyanate is about 100% by mass. More preferably, the content of hexamethylene diisocyanate is in the range of about 50% to about 90% by mass.

In accordance with the experiment to be described later, it is possible to improve the bendability, the close adhesion, and the noncohesiveness more efficiently by regulating the contents as described above.

In the present invention, it is preferable that an NCO index (—NCO/—OH) of hexamethylene diisocyanate and diphenylmethane diisocyanate is in the range of about 1 to 2.

In the present invention, the acrylic glass and the curing agent comprising hexamethylene diisocyanate (HDI) are included in the wiring members. It is possible to improve the migration resistance by using the acrylic glass even when the wiring members including the Ag are used. Moreover, since at least HDI is included in the curing agent, it is possible to improve the bendability of the flexible printed circuit board and the close adhesion between the insulating substrate and the coating member and between the coating member and the wiring members.

### BRIEF DESCRIPTION OF THE DRAWINGS

FIG. 1 is a perspective view of a flexible printed circuit board in which electric components are mounted.

FIG. 2 is a partially sectional view of the flexible printed circuit board taken along line II-II of FIG. 1 as viewed in a direction of the arrows of FIG. 1.

FIG. 3 is a graph of the number of bendings and the transmission in accordance with a content of HDI on the basis of Table 1.

FIG. 4 is a graph illustrating a relation between time and insulation resistance in an example and a comparative example.

FIG. 5A illustrates that ion migration does not occur in the example where an acrylic glass is used as a coating member. FIG. 5B illustrates that the ion migration occurs in the comparative example where a polyester resin is used as the coating member.

### DESCRIPTION OF THE PREFERRED EMBODIMENT

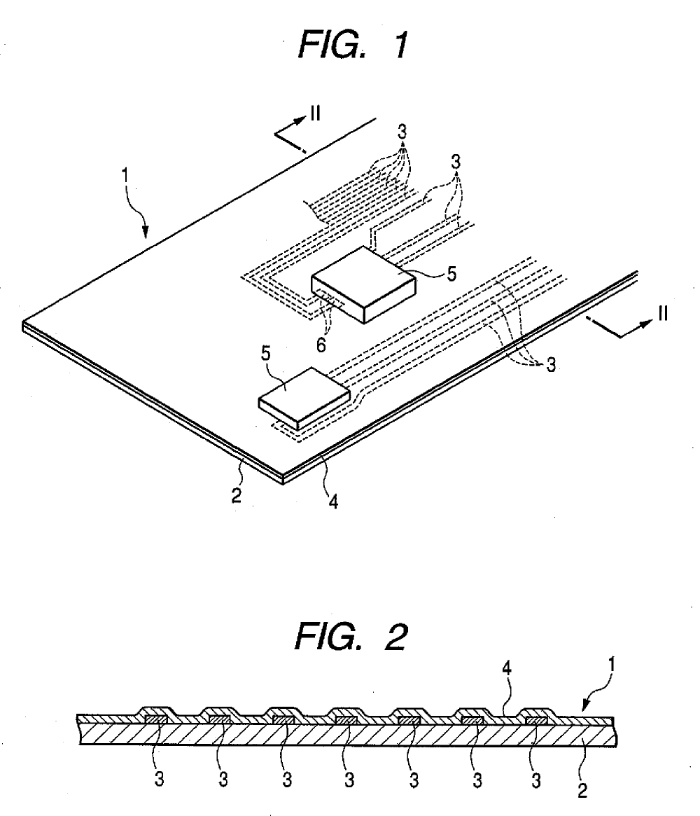

FIG. 1 is a perspective view of a flexible printed circuit board in which electric components are mounted and FIG. 2 is a partially sectional view of the flexible printed circuit board taken along line II-II of FIG. 1 as viewed in a direction of the arrows of FIG. 1.

As shown in FIGS. 1 and 2, a flexible printed circuit board 1 is configured to include an insulating substrate 2, a plurality of wiring members 3. For example, the plurality of wiring members 3 is formed in a pattern on the insulating substrate 2 by a screen printing. The flexible printed circuit board 1 is further configured to include an insulating coating member 4 covering the wiring members 3 and the insulating substrate 2 between the wiring members 3 and formed by the screen printing.

It is preferable that the insulating substrate 2 is a resin film having flexibility. Accordingly, it is possible to improve bendability of the flexible printed circuit board 1. For example, it is preferable that the insulating substrate 2 is a polyethylene terephthalate (PET) film since it is inexpensive and has excellent bendability. When higher transparency is required for the insulating substrate 2, the insulating substrate 2 may be a polyethylene naphthalate (PEN) film. When higher flame resistance is required for the insulating substrate 2, the insulating substrate 2 may be a polyimide film. The insulating substrate 2 may not have a single layer structure. For example, insulating substrate 2 may have a multilayered structure with a reinforcing plate (for example, a synthetic resin plate) provided in a bottom surface of the resin film by using an adhesive, such as an adhesive agent or a tackness agent.

The wiring members 3 are formed in a predetermined pattern by the screen printing. The wiring members 3 are formed of an Ag coated film. “Ag coated film” is a film including Ag particles that is conductive and a binder resin. The binder resin may be a thermosetting resin and a thermoplastic resin. Examples of the binder resin includes a polyimide resin, a bismaleimide resin, an epoxy resin, a phenol resin, acrylic glass, a polyester resin and a polyvinyl chloride. The Ag coated film may contain a curing agent or other additives.

Since the wiring members 3 are formed of the Ag coated film, it is possible to form the wiring members 3 at a low price and with lower electric resistance of the wiring members 3, have excellent bendability, and form the wiring members 3 in the predetermined pattern.

In one embodiment of the present invention, the acrylic glass is used for the coating member 4. The acrylic glass may include any one of an acrylic ester resin or a methacrylic acid ester resin or both of them. A molecular weight of the acrylic glass is in the range of 10,000 to 120,000, and it is preferable that the molecular weight is 100,000.

In another embodiment of the present invention, both hexamethylene diisocyanate (hereinafter, referred to as “HDI”) and diphenylmethane diisocyanate (hereinafter, referred to as “MDI“) are included in the coating member 4 as the curing agent.

A content of an NCO index (—NCO/—OH) as the curing agent in the coating member 4 is preferably in the range of about 1 to 2.

In yet another embodiment of the present invention, when the total content of HDI and MDI is about 100% by mass, the content of HDI is preferably in the range of about 33% to about 90% by mass. When the content of HDI becomes smaller than about 33% by mass, the content of MDI becomes greater than about 67% by mass. Accordingly, the bendability of the flexible printed circuit board 1 is deteriorated because MDI is harder than HDI. In addition, close adhesion between the insulating substrate 2 and the coating member 4 and between the wiring members 3 and the coating member 4 is deteriorated. When the content of HDI becomes greater than about 90% by mass, the content of MDI becomes smaller than about 10% by mass. Accordingly, noncohesiveness (non-tack property) of a surface of the coating member 4 is lowered. That is, stickness of the surface of the coating member 4 is increased.

The content of HDI is preferably in the range of about 50% to about 90% by mass. Accordingly, the bendability of the flexible printed circuit board 1 can be improved more effectively.

In one embodiment of the present invention, since the coating member 4 is formed of the acrylic glass having excellent water resistance, it is possible to prevent ion migration of the wiring members 3 formed of the Ag coated film properly. Experiments to be described later prove that migration resistance can be more properly improved by forming the coating member 4 of the acrylic glass in comparison with a conventional example of the coating member 4 formed of the polyester resin.

In another embodiment of the present invention, the mixture of HDI and MDI is used as the curing agent in the coating member 4.

The experiments to be described later prove that the close adhesion between the insulating substrate 2 and the coating member 4 and between the wiring members 3 and the coating member 4 is lowered and the bendability of the flexible printed circuit board 1 is deteriorated when the curing agent contains MDI only. Meanwhile, the experiments to be described later prove that the noncohesiveness (non-tack property) of the flexible printed circuit board 1 is lowered when the curing agent contains HDI only.

Accordingly, the mixture of HDI and MDI is used as the curing agent. As a result, it is possible to improve the close adhesion, the bendability and the noncohesiveness (non-tack property). It is possible to improve the close adhesion, the bendability and the noncohesiveness (non-tack property) more properly by regulating the contents of HDI and MDI in the above-mentioned range.

The curing agent may contain HDI only when the noncohesiveness does not particularly matter.

In yet another embodiment of the present invention, the coating member 4 has a high transmission, and specifically, has a transmission of 80% or more. The transmission is a total light transmission acquired by JIS K 7105 Testing Method.

For example, when a backlight (a lighting device) is provided under the flexible printed circuit board 1 and a light beam transmits through the flexible printed circuit board 1, it is necessary for the coating member 4 to have the high transmission. In the embodiments of the present invention, it is possible to ensure the transmission is more than 80% as described above.

In still another embodiment of the present invention, since the insulating substrate 2 is formed of the PET film and the wiring members 3 are formed of the Ag coated film, the flexible printed circuit board 1 can be manufactured at a low price.

As shown in FIG. 1, electrodes 6 connected to the wiring members 3 are formed under electric components 5 mounted on the flexible printed circuit board 1. The coating member 4 is not provided at least on the electrodes 6 (preferably, entire areas on which the electric components 5 are mounted). Since the coating member 4 is not provided on the electrodes 6, the electrodes 6 can be conductively connected to the electric components 5. The electrodes 6 may be the same Ag coated film as the wiring members 3, but may be a different one. For example, when a soldering process is performed between the electrodes 6 and the electric components 5, a material having excellent solder wettability is selected for the electrodes 6.

Uses of the flexible printed circuit board 1 shown in FIG. 1 are not particularly limited. For example, the flexible printed circuit boards 1 according to the embodiments of the present invention can be used for a removable printed circuit board of a connector.

According to one embodiment of the present invention, it is possible to maintain excellent migration resistance of the flexible printed circuit board 1 even when the pitch between the wiring members 3 is further narrowed for use in a small electronic apparatus, such as a mobile phone, or the flexible printed circuit board is used in a poor environment of high temperature or high humidity. Since the flexible printed circuit board 1 has excellent bendability or noncohesiveness (non-tack property), the flexible printed circuit board 1 has excellent attachment property to an electronic apparatus. Moreover, since the flexible printed circuit board 1 has excellent close adhesion between the insulating substrate 2 and the coating member 4 and between the wiring members 3 and the coating member 4 as well as the excellent migration resistance, it is possible to extend lifetime of the electronic apparatus.

### EXAMPLES

Experiments were carried out to measure bendability, transmission, noncohesiveness (non-tack property), and close adhesion between a coating member and an insulating substrate and between the coating member and the wiring members of a flexible printed circuit board in accordance with varying contents of HDI.

Sample used for the experiments had a configuration in which wiring members of an Ag coated film having a line width of 0.125 mm and a pitch of 0.25 mm were formed on a PET film having a thickness of 75 μm and a coating member of an acrylic glass. An isocyanate curing agent was formed on the wiring members and the PET film between the wiring members. An NCO index (—NCO/—OH) was set to be in the range of about 1 to 2.

In the experiments, a plurality of samples, each of which had a different mixture rate of HDI and MDI (the total content of hexamethylene diisocyanate and diphenylmethane diisocyanate was about 100% by mass), was provided and the bendability, the transmission, the noncohesiveness (non-tack property) and the close adhesion was obtained.

The bendability was evaluated in the number of bendings where a predetermined load was applied to the flexible printed circuit board until the wiring members were disconnected in a bending process. When the number of bendings is large, the bendability is excellent.

The transmission was evaluated in the total light transmission based on the JIS K 7105 by using an Ihac 75 model manufactured by Ihara Electronic Industries.

The noncohesiveness (non-tack property) was evaluated by measuring a power required when applying the predetermined load to a top and a bottom of the flexible printed circuit board and removing the predetermined load.

The close adhesion was evaluated by a cross-cut test based on JIS K 5600. As an evaluation method, the number (square) of remaining samples among 100 squares of samples was obtained after performing the cross-cut test. The close adhesion was improved as the number of remaining samples increased.

The experiment results are shown in the following Table 1.

TABLE 1

| | MHI:HDI = | MHI:HDI = | MHI:HDI = | MHI:HDI = |
|---|---|---|---|---|
| | 0:100 | 10:90 | 50:50 | 100:0 |
| | (wt %) | (wt %) | (wt %) | (wt %) |
| Transmission | 82% | 82% | 82% | 78% |
| Close | [100/100] | [100/100] | [100/100] | [0/100] |
| Adhesion | | | | |
| Bendability | 300 | 270 | 150 | 1 |
| Tack | 10 g/cm² | 0 g/cm² | 0 g/cm² | 0 g/cm² |
| Property | | | | |

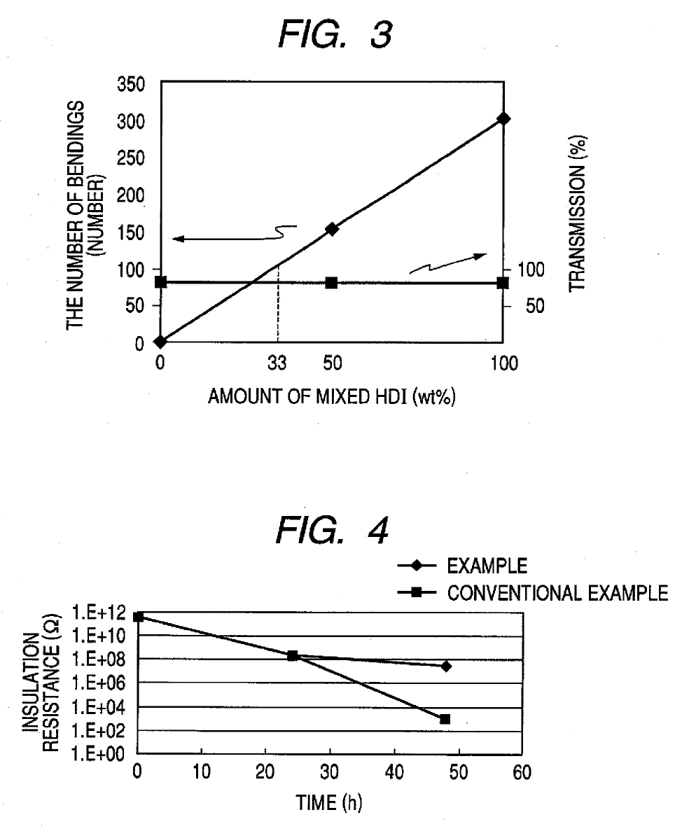

FIG. 3 is a graph of the number of bendings and the transmission in accordance with the HDI content on the basis of Table 1.

As shown in Table 1 and FIG. 3, when the HDI content was increased, the number of bendings was increased. Therefore, it can be seen that the bendability has been improved. When the HDI content was equal to or more than about 33% by mass, it can be seen that the number of bendings has been increased to 100 times or more.

When the HDI content was equal to or more than about 50% by mass, it can be seen that the number of bendings has been increased to 150 times or more and transmission has been increased to about 80% or more.

Numerators in fractions showing the close adhesion in Table 1 indicate the number (square) of remaining samples among 100 squares of samples. As was clear from the experiments, when the MDI content was about 100% by mass, it can be seen that the close adhesion was deteriorated. As shown in Table 1, when the HDI content was equal to more than 50% by mass, it can be seen that the excellent close adhesion can be ensured.

As shown in Table 1, when the HDI content was about 100% by mass, there was cohesiveness (the tack property) of about 10 g/cm². Accordingly, it can be seen that it was preferable that the HDI content was equal to or less than about 90% by mass to realize the tack property of zero as shown in Table 1.

From the experiment results, the HDI content was set to be in the range of about 33% to about 90% by mass, preferably in the range of about 50% to about 90% by mass.

Next, insulation resistance was measured under the following conditions for an example of a coating member including the acrylic glass, HDI (about 60% by mass) and MDI (about 40% by mass) in which an NCO index was adjusted in the range of about 1 to 2 and a comparative example of a coating member formed of a polyester resin. The insulating substrate and the wiring members used in the experiments of Table 1 were used in both of the example and the comparative example.

Under the condition of a temperature of about 120° C. and a humidity of about 100%, a voltage of about 5V was applied to between the wiring members and insulation resistance between the wiring members was measured. As shown in FIG. 4, high insulation resistance was maintained with the lapse of time in the example. However, the insulation resistance was lowered as time was elapsed in the comparative example. Accordingly, it can be seen that sufficient insulating property could not be maintained between the wiring members. This result was obtained under all test conditions, such as in a temperature of about 85° C. and a humidity of about 85% or in a temperature of about 120° C. and a humidity of about 85%.

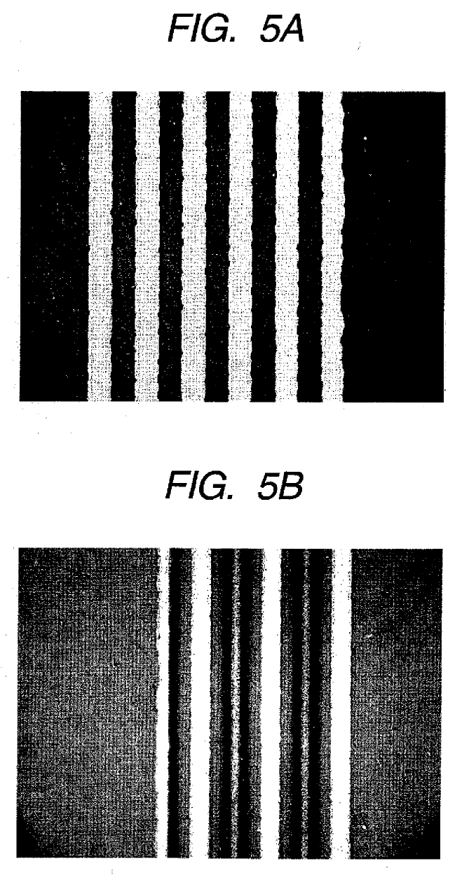

FIG. 5A illustrates a surface of the printed circuit board in an example and FIG. 5B illustrates a surface of the printed circuit board in a comparison example. No particular changes were found in the example of FIG. 5A. However, darkly-discolored portions were seen in the conventional example of FIG. 5B. These were formed due to silver oxide generated by ion migration. On the other hand, the ion migration was not found in the example.

What is claimed is:

1. A printed circuit board comprising:
an insulating substrate;
a plurality of wiring members disposed on the insulating substrate; and
a coating member that covers the wiring members and the insulating substrate between the wiring members,
wherein the wiring members include Ag, and the coating member is formed of an acrylic glass and a curing agent comprising hexamethylene diisocyanate.

2. The printed circuit board according to claim 1, wherein the curing agent further comprises diphenylmethane diisocyanate.

3. The printed circuit board according to claim 2, wherein the content of hexamethylene diisocyanate is in the range of about 33% to about 90% by mass when the total content of hexamethylene diisocyanate and diphenylmethane diisocyanate is about 100% by mass.

4. The printed circuit board according to claim 3, wherein the content of hexamethylene diisocyanate is in the range of about 50% to about 90% by mass.

5. The printed circuit board according to claim 2, wherein an NCO index (—NCO/—OH) of hexamethylene diisocyanate and diphenylmethane diisocyanate is in the range of about 1 to 2.

6. The printed circuit board according to claim 1, wherein the insulating substrate is formed of a resin selected from a group consisting of polyethylene terephthalate (PET), polyethylene naphthalate (PEN), and polyimide.

7. The printed circuit board according to claim 1, wherein the acrylic glass is formed of an acrylic ester resin or a methacrylic acid ester resin or a combination thereof.

8. A device including a printed circuit board, the printed circuit board comprising:
an insulating substrate;
a plurality of wiring members disposed on the insulating substrate; and
a coating member that covers the wiring members and the insulating substrate between the wiring members,
wherein the wiring members include Ag, and the coating member is formed of an acrylic glass and a curing agent comprising hexamethylene diisocyanate.

9. The device according to claim 8, wherein the curing agent further comprises diphenylmethane diisocyanate.

10. The device according to claim 9, wherein the content of hexamethylene diisocyanate is in the range of about 33% to about 90% by mass when the total content of hexamethylene diisocyanate and diphenylmethane diisocyanate is about 100% by mass.

11. The device according to claim 10, wherein the content of hexamethylene diisocyanate is in the range of about 50% to about 90% by mass.

12. The device according to claim 9, wherein an NCO index (—NCO/—OH) of hexamethylene diisocyanate and diphenylmethane diisocyanate is in the range of about 1 to 2.

13. The device according to claim 8, wherein the insulating substrate is formed of a resin selected from a group consisting of polyethylene terephthalate (PET), polyethylene naphthalate (PEN), and polyimide.

14. The device according to claim 8, wherein the acrylic glass is formed of an acrylic ester resin or a methacrylic acid ester resin or a combination thereof.

15. A method for fabricating a printed circuit board comprising:
forming an insulating substrate;
forming a plurality of wiring members on the insulating substrate; and
forming a coating member that covers the wiring members and the insulating substrate between the wiring members,
wherein the wiring members include Ag, and the coating member comprises an acrylic glass and a curing agent that comprises hexamethylene diisocyanate.

16. The method for fabricating a printed circuit board according to claim 15, wherein the curing agent further comprises diphenylmethane diisocyanate.

17. The method for fabricating a printed circuit board according to claim 16, wherein the content of hexamethylene diisocyanate is in the range of about 33% to about 90% by mass when the total content of hexamethylene diisocyanate and diphenylmethane diisocyanate is about 100% by mass.

18. The method for fabricating a printed circuit board according to claim 17, wherein the content of hexamethylene diisocyanate is in the range of about 50% to about 90% by mass.

19. The method for fabricating a printed circuit board according to claim 16, wherein an NCO index (—NCO/—OH) of hexamethylene diisocyanate and diphenylmethane diisocyanate is in the range of about 1 to 2.

20. The method for fabricating a printed circuit board according to claim 15, wherein the insulating substrate comprises a resin selected from a group consisting of polyethylene terephthalate (PET), polyethylene naphthalate (PEN), and polyimide.

21. The method for fabricating a printed circuit board according to claim 15, wherein the acrylic glass comprises an acrylic ester resin or a methacrylic acid ester resin or a combination thereof.
